(19) United States
(12) Patent Application Publication
(10) Pub. No.: US 2008/0144203 A1
(43) Pub. Date: Jun. 19, 2008

(54) Hunting apparatus utilizing reflective material

(76) Inventor: John A. Williams, Purvis, MS (US)

Correspondence Address: Mr. Timothy D. Smith, 5075 Canton Heights Dr., Jackson, MS, 39211, US

(21) Appl. No.: 11/637,969

(22) Filed: Dec. 14, 2006

(51) Int. Cl. G02B 5/08

(52) U.S. Cl. 359/866; 359/871

(57) ABSTRACT

This invention is to be used primarily in the hunting or outdoor viewing arena and utilizes mirrored panels to camouflage the user of said invention from detection by wildlife. These mirrored panels are thin, lightweight, strong, scratch resistant and provide a true image of the surroundings so as to facilitate the perfect camouflage. In any the terrain, this invention allows the user to blend in without detection.

The mirrored panels can be manufactured out of strong and lightweight acrylic, but other substances can be effective as well. The bottom of at least two of the panels of the invention are beveled in such a way as to allow the invention to lean slightly forward. This allows the mirrored panels to reflect their immediate surroundings and prevents flaring of the sun off of the mirror itself. The panels are connected together via durable and rigid hinges. These hinges allow the invention to be folded up and transported very easily from one location to the next and also facilitate easy storage. The back portion or side of the panels in painted a drab color or a camouflage color and is what is seen by any viewer when the invention is folded up.

### CROSS REFERENCES TO RELATED APPLICATIONS

U.S. Patent Documents

| | | | |
|---|---|---|---|
| 4,123,869 | November, 1979 | Witt | 43/1 |
| 4,506,467 | March, 1985 | Strung | 43/1 |
| 5,007,473 | April, 1991 | Evenson | 160/135 |
| 5,054,507 | October, 1991 | Sparks | 135/97 |
| 5,373,863 | December, 1994 | Prizio | 135/97 |
| 5,592,960 | January, 1997 | Williams | 135/87 |
| 6,553,725 | April, 2003 | Washington | 52/64 |
| 6,655,102 | December, 2003 | LaRue | 52/311.1 |

### STATEMENT REGARDING FEDERALLY SPONSORED RESEARCH AND DEVELOPMENT

Not Applicable

### REFERENCE TO A “SEQUENTIAL LISTING,” A TABLE, OR COMPUTER PROGRAM LISTING APPENDIX SUBMITTED ON A COMPACT DISC

Not Applicable

### BACKGROUND OF THE INVENTION

(1) Technical Field of Invention

The general purpose of this invention is to provide or facilitate a means by and through which a person can conceal themselves from detection by animals that they may be hunting or trying to photograph. This invention utilizes mirrored panels to accomplish this task. The invention is lightweight, easy to handle and set up, and most importantly very effective.

(2) Description of Prior Art

Throughout the years there have been several patented inventions that utilize mirrors in an effort to conceal a user in a hunting or outdoors context. These inventions have presented themselves in a multitude of shapes, sizes and varieties, yet none of these inventions have attained market success because of critical flaws that impede the true goal of a “blind” used to conceal a person from detection by animals or other humans.

Many of the inventions have been too bulky to transport from location to location with any amount of ease. Moreover, even the smaller inventions in this general field have failed either because they are heavy, or more importantly, they have not provided a true, non-distorted mirror image of the surroundings. The present invention that is the subject of this application accomplishes all of the goals and desires of a hunter in that it is portable, lightweight, easy to use, quickly set up and taken down, and most importantly, facilitates absolute camouflage in what ever surroundings it is placed within free of distortion.

### BRIEF SUMMARY OF THE INVENTION

The present invention is an apparatus that consists of mirrored acrylic or the like lightweight panels connected via hinges. The bottom portion of these panels are beveled at an angle that facilitates a forward lean of the apparatus when set up so that the immediate surrounding terrain is perfectly reflected off of the mirrored surface of the panel.

This invention typically consists of two or three mirrored panels, although this application should not be construed to limit the invention to this particular number of panels as it could consist of more than three panels.

These hinged mirrored panels can fold in on top of one another in such a fashion as to allow them to take the shape of only one panel. The invention is equipped with straps, preferably made of Velcro®, which function to hold the panels together when in transit. Other means are available to hold the panels in place when the invention is in its folded or non-reflective position. The invention is also equipped with backpack styled harness straps that allow the invention to be transported over the user's shoulder or worn by the user like a backpack while in transit. An alternate version of the invention is manufactured without backpack style straps. This version is carried in a custom manufactured carrying case or backpack. Because the panels are thin, even when folded together, the invention takes of little space and is exceptionally lightweight. A typical hunter's backpack could be worn over the top of the invention while it is being carrying over the shoulder or even worn like a backpack because of the thin nature or the invention.

When in use as a blind, the panels are folded open and the apparatus is placed on the ground or a semi-level surface. The surface upon which the invention rests does not have to be completely level for the apparatus to function properly. The beveled end of the panels is in contact with the ground so as to facilitate a slight forward lean of the invention when it is on the ground. This is critical because the slight forward lean allows the mirrored panels to reflect the immediate surroundings on the ground. This image is then reflected forward in such a way that any animal, or human for that matter, that is looking in the direction of the invention is unable to see it as they see the reflection of the surrounding ground instead, be it grass, dirt, leaves, pine needles, snow or whatever is in the immediate viscidity of the invention. In another use, the invention can be placed on the ground or other applicable surface inverted or upside down with the beveled portion at the top as opposed to the bottom. The invention will then reflect objects directly in front of the panels such as turkey decoys. This enables a turkey hunter to utilize one decoy and make it look like several decoys as the image of the single decoy is reflected off of the panels as opposed to the ground around the invention when used for its standard purpose. If a turkey, or other wild prey, approach the invention close enough, they will actually see their own reflection. Many animals are fooled by their own reflection and assume it is another animal. Therefore, in this particular set up and use, the invention acts as a means of wild game attractant.

The user sits on the opposite side of the panels from the reflective surface referred to as the reverse side or portion of the panels. This reverse side is painted or colored a drab or camouflage color so as not to give away the location of the blind should an animal approach the invention and user from behind. The backpack straps are also located on and connected to the inner portion of the panels when utilized on the invention.

When in transit the invention is folded up and the reverse side of the invention faces the outside. In other words, the reflective panels or reflective materials are concealed when the invention is folded up. Therefore, the drab or camouflage side of the panels is what is seen, not the reflective material. This is of use so the user does not reflect light that may allow the user to be seen while moving through the woods or the field.

A three panel version of the invention will have four hinges connecting the panels together. There will be a central panel with a panel on either side. This central panel will have two connection points via hinges with each panel on each side. The two panel version of the invention will have two hinges that connect the two panels. The invention when manufactured with more than three panels will have an equal ratio of hinges. There are typically two connection points between in two panels.

The hinges must be of sufficient strength and durability to allow the invention to be adequately rigid when open and placed on the ground or other appropriate surface. Metal or aluminum hinges have been used on previous prototypes, however other materials are suitable as well. The preferred embodiment is an acrylic hinge because it is light-weight and matches the acrylic panels well in style and substance.

This invention will typically be used as a hunting blind and is extremely novel in its functionality. It is lightweight and easily transported. The invention can be set up by the user in a matter of seconds. The invention is virtually invisible to the naked eye. Hunters desire to conceal themselves from their prey. This invention provides for the ultimate in camouflage in that it utilizes the surroundings it is place in, no matter what they are. Even the best modern camouflage is effective in limited hunting situations and surroundings. Other blinds that use mirrors are cumbersome and not easily used to any degree of effectiveness. Inventors in the past have tried to use double-sided mirrors. They have attempted to use reflective material that has a foil or paper component. This invention has used an acrylic mirrored surface. The acrylic provides for the best reflection and is lightweight and easy to use.

In many ways this invention is superior to its predecessors in that it provides the ultimate camouflage in a small, lightweight and easy to use package. It is particularly useful to turkey hunters in that it provides unequaled concealment and it small and portable enough to set up and take down with very little effort on the part of the user. It can be easily carried with out interfering with the other equipment the user may have with him and can be carried for great lengths of time due to its light weight.

### BRIEF DESCRIPTION OF SEVERAL VIEWS OF THE DRAWINGS

FIG. 1 illustrates the invention in its three panel version in an open position as it would be utilized to conceal a user when placed on the ground or other appropriate surface.

FIG. 2 illustrates the invention again in its three panel embodiment from behind. This figure also illustrates the straps used to carry the invention. Another embodiment of the invention not pictured is without the straps.

FIG. 3 illustrates the invention's center reflective or mirrored panel and illustrates the hinges that connect to the other panels.

FIG. 4. Illustrates the inventions beveled panel with the bottom edge of the reflective panel being the beveled edge. This is the edge that will typically be in contact with the ground and facilitates a slight forward lean to the invention so as to reflect the surrounding areas off of the reflective surface of said panels.

### DETAILED DESCRIPTION OF THE INVENTION

The present invention consists of mirrored reflective panels connected with hinges so as to facilitate a folding mechanism by which the invention can be set up and placed on the ground or on another applicable surface or folded up and transported. The invention is to be used as a device for concealment for hunters or those who enjoy viewing wildlife. The mirrored nature of the panels reflects the immediate surroundings and effectively camouflages the invention and the user to the naked eye of animals and humans alike.

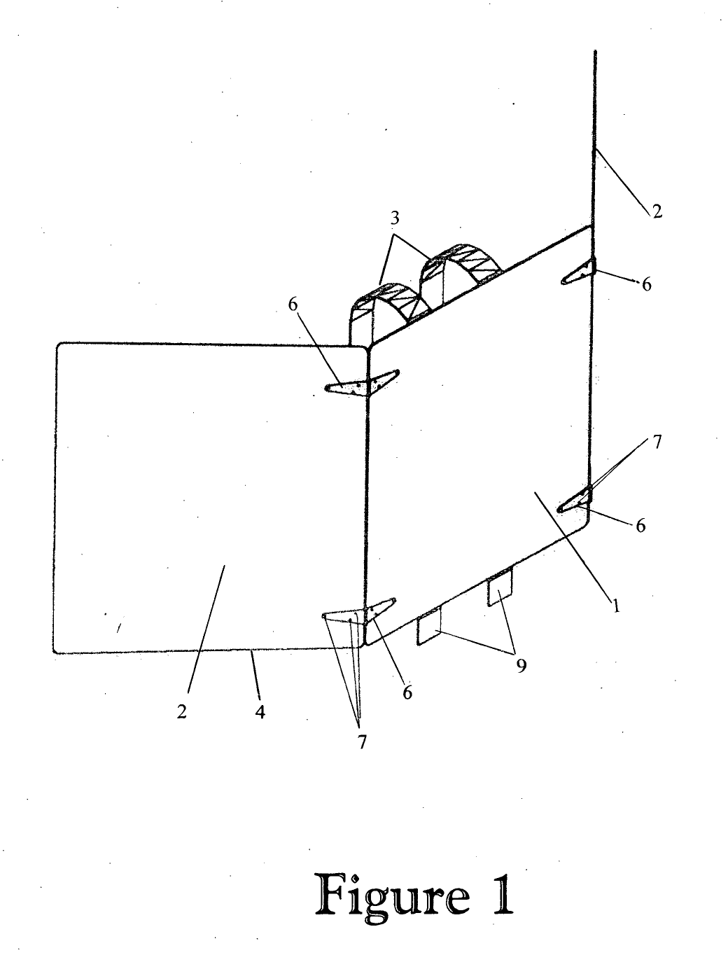

Referring to FIG. 1 through FIG. 4, the invention in comprised primarily of mirrored or reflective panels (1) and (2) connected together by hinges (6). Said hinges (6) are attached to the mirrored or reflective panels (1) and (2) by a rivet or screw (7). The back portion of one of the reflective panels (1) and (2) has attached to it straps (3) that can be used either over both shoulders of the user in transit like a backpack or over one shoulder like a sling. Another embodiment of the invention does not utilize the straps (3). Instead, the invention is configured as seen in the drawings without straps (3) and is carried in a customized carrying case or backpack.

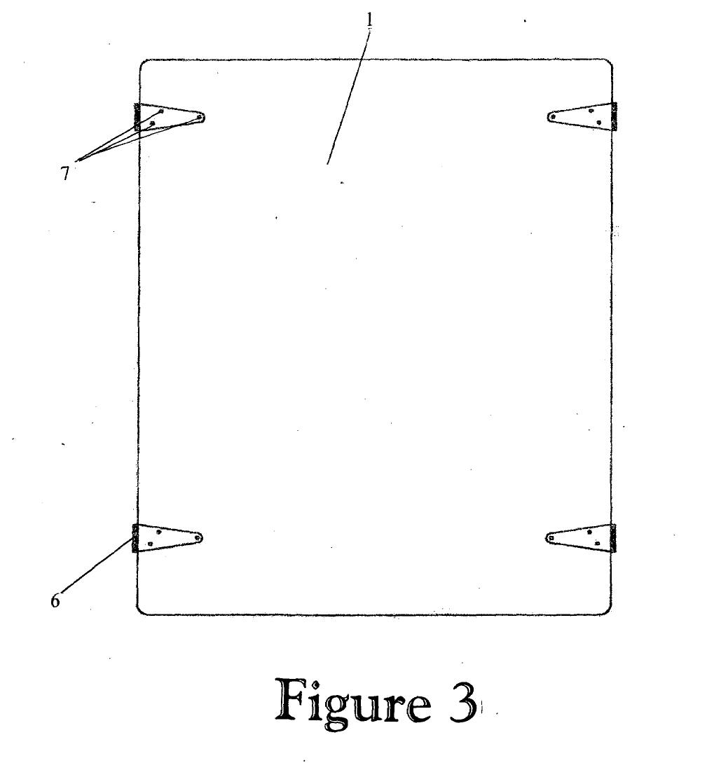

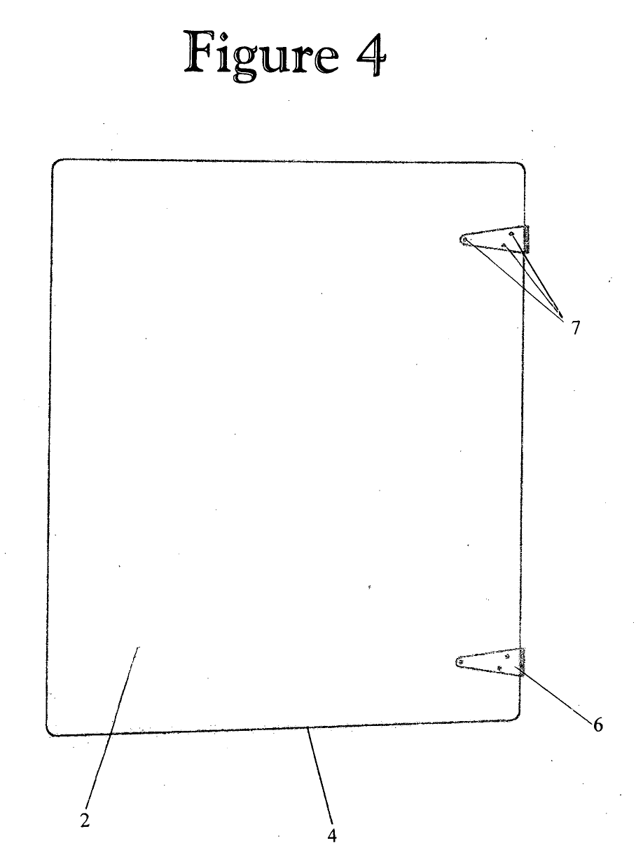

Referring to FIGS. 3 and 4 specifically, the reflective panels (1) and (2) should be manufactured with sufficient size so that the user can sit or kneel behind the invention when it is set up and said user be sufficiently concealed from the game being sought or hunted. The panels (1) and (2) can be manufactured out of a number of reflective materials, however reflective acrylic seems to meet the appropriate requirements as good as any material in that it is lightweight, durable, typically scratch resistant, and provides a undistorted image. The back portion of the reflective panels (8) is preferably colored or painted a drab color or camouflage color so that it blends in with typical outdoor settings. However, this back portion (8) can be painted any appropriate color according to the desired use of the invention. The invention can utilize and be manufactured to have as many reflective panels (1) and (2) as deemed necessary. The figures illustrate a two or three panel version.

Referring to FIGS. 1, 2 and 4, at least two of the panels (2) will exhibit a beveled edge (4) at the bottom of said panel (2). For instance, in the two panel version of the invention, both reflective panels (2) will have a beveled bottom (4). In the three panel version of the invention the center reflective panel (1) will not contain a beveled edge but will exhibit a flat edge on the bottom of the panel (1). The beveled edge (4) allows the invention to tilt forward slightly so as to reflect the immediate surroundings off of the panels (1) and (2). The bottom edge (4) is beveled at an angle inward towards the center of the invention. As a result, the outer bottom edge (4) of the beveled panels (2) will be lower than the inner bottom edge (4) of the panel (2) angling up towards the middle of the invention. This edge (4) allows the invention to lean or pitch forward just enough to reflect the immediate surroundings and is a critical aspect of the invention as a whole. It is important that the invention reflect what is immediately in front of the panels (2). The beveled edge (2) facilitates this lean and the resulting undistorted reflection of the ground below. By leaning forward, sun spots or mirrored reflections from the sun are eliminated as well. A loop or string can be attached to the back portion of the reflective panels (8) at the bottom of said panels (8) and a spike can be driven into the ground and the loop placed around this spike to provide support so that the invention does not fall forward if it is accidently pushed forward by the user or a strong wind hits the invention from behind causing it to blow forward. This component is not necessary but recommended. This component simply acts to stabilize the invention.

Referring to FIG. 1 through 4, the panels (1) and (2) are attached to one another by rigid hinges (6) that are attached to said panels by a rivet or screw (7). The hinges (6) should be of sufficient rigidity to hold the panels (1) and (2) together without much shifting or movement, yet must be fashioned out of a lightweight material so as to keep the relative total weight of the invention to a minimum. A light alloy or aluminum tends to work well but the hinges (6) should not be limited to just those substances. A preferred embodiment is an acrylic hinge. The acrylic hinge exhibits sufficient strength and rigidity while being light-weight. They also function to reflect in a identical fashion as the panels (1). Typically, two hinges (6) hold two panels (1) and (2) together. Therefore a two-panel version of the invention will have a total of two hinges (6). A three panel version of the invention will have four total hinges (6). On the three panel version, the center reflective panel (1) will have two hinges (6) on either vertical side attached to a beveled panel (2) on either side. The hinges (6) are to be attached on the side of the reflective material or out side of the panel (1) and (2). This allows the mirrored or reflective sides of the panels (1) and (2) to fold in towards one another while in transit. The back portion (8) of the panels (1) and (2) is the portion that is then seen while the reflective portion is hidden so as not to provide a reflective surface while in transit. Connecting straps (9) that either button, snap or utilize Velcro® can be connected to either the bottom of sides of the panels (1) and (2) that hold the panels (1) and (2) together while folded.

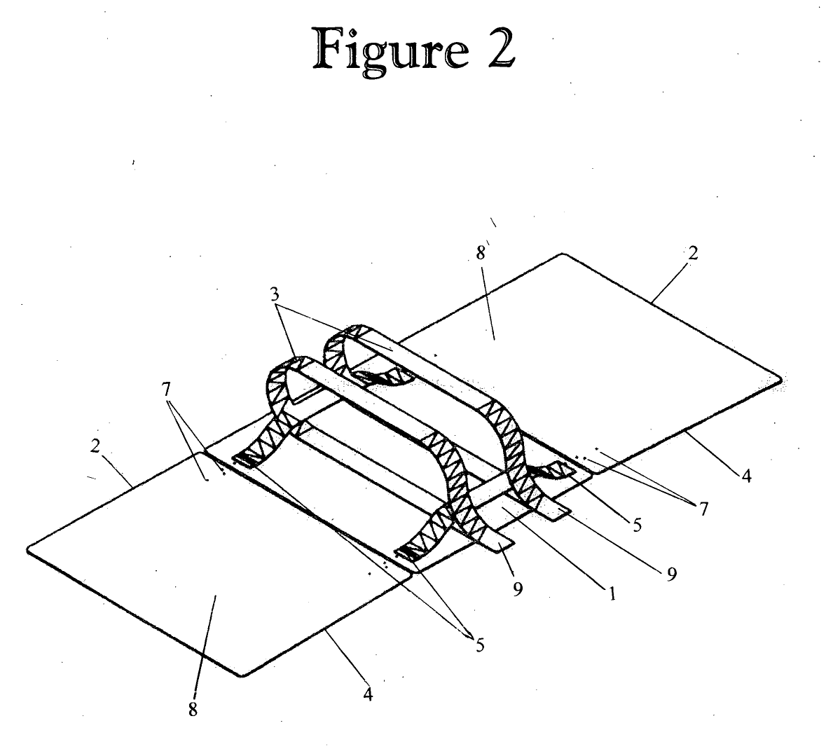

Referring to FIGS. 1 and 2 in particular, straps (3) are connected to the back portion (8) of one panel. These straps (3) are connected to the panel (8) by a screw or rivet. The straps (3) can be formed in loops so as to facilitate either a single shoulder sling or a backpack. When the invention is folded and used in transit these straps (3) allow the user to carry the invention over their shoulder or wear the invention like a backpack. The straps (3) are not necessary to the ultimate functionality and novel use of the invention which is reflection of the surroundings. As a result, one embodiment of the invention does not utilize said straps (3). Instead, a custom carrying case or backpack is used to carry the invention. The invention is light enough to easily be carried long distances by hand as well.

Referring to FIG. 1 through 4, when the invention is in use the panels (1) and (2) will be opened up and the invention will be placed on the ground or other applicable surface. The beveled edge (4) of the panels (2) causes the invention to lean forward at a slight angle so as to reflect the surroundings off of the mirrored, reflective outer surface of the panels (1) and (2). The user will sit down on the back portion side (8) of the invention to conceal themselves from their prey. The reflective surface will reflect an exact image of whatever surroundings it is placed in and thus make the invention virtually invisible, thus hiding the user behind the panels (1) and (2).

### DRAWINGS

The drawings referenced in this application are attached hereto.

I claim:

1. An apparatus for concealment consisting of:
two or more reflective mirrored panels of similar size and shape having a non-reflective reverse side;
two of the panels having beveled edges across the bottom edge of the panels slanted at a slight upward angle from the outside corner of the panel to the inner corner of the panel facilitating a slight forward lean when the apparatus is placed on a level or semi-level surface;
the panels being connected by hinges facilitating a pivotal range of motion about an axis of rotation wherein the non-reflective reverse side of the panels comprises the outside of the folded apparatus;
a connection means to secure the panels when folded together in a closed position.

2. A concealment apparatus as in claim 1, wherein:
the apparatus is comprised of two reflective panels, both of which have beveled edges across the bottom of the panels.

3. A concealment apparatus as in claim 1, wherein:
the apparatus is comprised of three or more reflective panels, the bottom of the middle panels being flat.

4. A concealment apparatus as in claim 1, wherein:
the reflective mirrored panels are comprised of reflective acrylic.

5. A concealment apparatus as in claim 1, wherein:
the reflective mirrored panels are comprised of another suitable reflective material such as reflective plastic.

6. A concealment apparatus as in claim 1, wherein:
the hinges are comprised of reflective acrylic.

7. A concealment apparatus as in claim 1, wherein:
the hinges are comprised of aluminum or metal.

8. A concealment apparatus as in claim 1, wherein:
the hinges are comprised of another suitable substance such as plastic.

9. A concealment apparatus as in claim 1, wherein:
straps are attached to the reverse side of the reflective panels by screws or rivets to facilitate a carrying means for transit when the apparatus is in a closed position.

10. A concealment apparatus as in claim 1, wherein:
one hinge connects the reflective panels.

11. A concealment apparatus as in claim 1, wherein:
more than one hinge connects the reflective panels.

12. A concealment apparatus as in claim 1, wherein:
the connection means is comprised of a snap or buckle.

13. A concealment apparatus as in claim 1, wherein:
the connection means is comprised of Velcro.

14. A concealment apparatus as in claim 1, wherein:
an anchor system is utilized to stabilize the apparatus when in use comprising one or more ground spikes attached to the panels by a line or cord.

15. A method of utilizing the concealment apparatus, comprising the steps of:
releasing the connection means;
unfolding the reflective panels;
placing the beveled portion of the reflective panels on the desired level to semi-level surface facilitating reflection of the immediate surroundings by the slight forward lean of the panels;
sitting or resting behind the apparatus on the opposite side of the reflective surface to conceal one's self.

16. A method of utilizing the concealment apparatus, comprising the steps of:
releasing the connection means;
unfolding the reflective panels;
placing the non-beveled or top portion of the reflective panels on the desired level to semi-level surface facilitating reflection of objects immediately in front of the panels such as animal decoys;
sitting or resting behind the apparatus on the opposite side of the reflective surface to conceal one's self.
